(19) United States
(12) Patent Application Publication
(10) Pub. No.: US 2019/0128235 A1
(43) Pub. Date: May 2, 2019

(54) Hydro Enhanced Airjet Impeller Electricity Generating System

(71) Applicants: Donald Udel Brumfield, Chowchilla, CA (US); Gregory Scott Brumfield, Chowchilla, CA (US)

(72) Inventors: Donald Udel Brumfield, Chowchilla, CA (US); Gregory Scott Brumfield, Chowchilla, CA (US)

(21) Appl. No.: 16/033,838

(22) Filed: Jul. 12, 2018

Related U.S. Application Data
(60) Provisional application No. 62/707,360, filed on Oct. 31, 2017.

(51) Int. Cl. F03B 11/00; F03B 13/10

(52) U.S. Cl. CPC F03B 11/002; F03B 13/10

(57) ABSTRACT

A electricity generating system consists of the following components: Supply of compressed air. Non-corrosive water filled circular “tank’ structure. Cribbage to secure equipment. Air jet Impellers. Air recapturing hoods. Air injection nozzles. Air entrapment chambers. Axial power transfer equipment for operating A.C. electricity generators. The supply of compressed air is obtained from several existing methods; such as a water wheel operating air compressing pumps. Compressed air is injected into air entrapment chambers attached to the impeller surface. Air entrapment chambers are nozzle filled at lowest reference point of circular tank. Chambers are filled in a rotation series. Impellers are rotated by the air lift forces being applied to one side of an imaginary vertical plane. Air released from impeller is captured and reused to drive the next in line impeller. The leveraged rotational force of the impeller axle drives a hydraulic pumps which spins an electricity generator.

### RELATED APPLICATION

Application No. 62/707,360 filing date Oct. 31, 2017 Confirmation No. 2888 this is a provisional patent application.

### STATEMENT OF FEDERALLY SPONSORED RESEARCH OR DEVELOPMENT

Not application.

### THE NAMES OF THE PARTIES TO A JOINT RESEARCH AGREEMENT IF THE CLAIMED INVENTION WAS MADE AS A RESULT OF ACTIVITIES WITHIN THE SCOPE OF A JOINT RESEARCH AGREEMENT

Not applicable.

### REFERENCE TO A “SEQUENCE LISTING”, A TABLE OF COMPUTER PROGRAM LISTING APPENDIX SUBMITTED ON A COMPACT DISC

Not applicable

### BACKGROUND FOR JUSTIFICATION OF THIS INVENTION

Whereas; The United States and its Citizens desire to become energy independent from other countries of the world. Do to supply and demand for clean energy the cost to purchasers has increased rapidly in recent years. New Hydro turbines using a high column of water are expensive and difficult to obtain legal permission to build. Sites are limited to building dams on water shed locations to store adequate acre feet of water for release to operate the turbine driven generators.

Whereas; Wind turbine generators require the wind to blow with sufficient force to operate their systems and we have no control of the wind, so this makes wind energy and unstable energy supply.

Whereas; solar energy depends on the sun to shine to produce photo-voltaic electricity and therefore doesn't work at nigh time or when weather conditions obscure the sun light.

Therefore: A demand exist for our energy system that can produce continuous clean dependable energy 24 hours per day at a reasonable kilowatt hour cost. “The Hydro enhanced air jet impeller electricity generating systems” uses two natural elements; (1) water (2) air.

Operational Process: The water is used in a conduit with a gradient horizontal flow of 250 cu. ft. per second to drive air pressure pumps. The water then continues traveling in its original conduit condition for its intended use. The captured compressed air becomes the force that generates the electric energy producing system. After using the compressed air to drive the energy producing system, it is release back into the atmosphere from which it was obtain. So neither element is diminished or altered from its natural state.

Background of the Invention: This invention was conceived by the co-inventors out of the concept that compressed air could be used to drive electric generator for meeting the energy needs of citizens in the United State. Both private consumption and commercial consumption of electric energy. The invention will also help the United States to become independent as a nation for energy supplies. The invention is non pollutant and leaves no carbon foot print. The main two elements used are air and water which our renewable natural resources readily available in the United States of America. We have develop a prototype that proved the concept has great potentiality for multiple uses of electricity throughout the world. The cost of production per kilowatt hour is very competitive to other systems such as Hydro, wind and solar.

### BRIEF SUMMARY OF THE INVENTION

the invention is designed to produce electric energy as an end product.

The systems operates using two natural resources:
1. Water: In a conduit (man-made of naturally flowing) with a gravitational flow of 250 cu. ft. per second or greater. The water is used to operate a wheel that drives air compressing pistons. The water is then returned to its normal path of flow.
2. Air: In a compressed state and stored in containers. The air is released at low pressure ranging from 16 PSI to 30 PSI (or greater) depending on quantity of air needed to drive the submerged air jet impellers. The spent air is released into the surrounding atmosphere.

The system is designed to have a cylindrical water filled tank to hold the submerged air jet impellers in a horizontally stacked position with their accompanying equipment components to transfer the derived power forces to drive electric generators.

The electricity derived from the hydro enhanced air jet impeller electricity generating system can be used as a stand-alone power system or tied to existing power grids to be used on demand.

The system used no solid fuels and leaves no carbon foot print. Whereas societies around the world are in need of electric power to pump, purify and move water to usable locations; we believe this state of the art invention can resolve many of these issues facing large populations

in desperate need for treated potable water to survive. The transportability of this electric energy source makes it available in most locations in the globe. Once in operation it can be run continuously. The system can be adapted for installation on most terrains throughout the world. It is more dependable than wind or solar systems and safer than nuclear systems.

### BRIEF DESCRIPTION OF THE SEVERAL VIEWS OF THE DRAWING

see attached sheets (two pages marked FIG. 1, FIG. 2 and FIG. 3).

FIG. 1 (Drawings Page 1) shows the composite parts to the invention using numbers 1 through 10.

FIG. 2 (drawings page 1) shows an enlarged drawing of a simulated air jet impeller mechanism using Number 11.

FIG. 3 (drawings Page 2) depicts relationship of air entrapment chambers to each other in the alfa prototype (no numbering necessary).

Note; Drawings are inserted between Number (8) and Number (9) in this check list sequence for filing a Non-provisional Utility patent application.

### DETAILED DESCRIPTION OF THE INVENTION

General Construction and composition of materials explanatory notes. All materials submerged or in contact with water are made with non-corrosive products or are corrosive resistant or coated with non-corrosive compounds to extend the life spam of their functionality. The air entrapment chambers are formed in a curved arch, the shape of their attachment surface matching the circular circumference face of the impeller assembly.

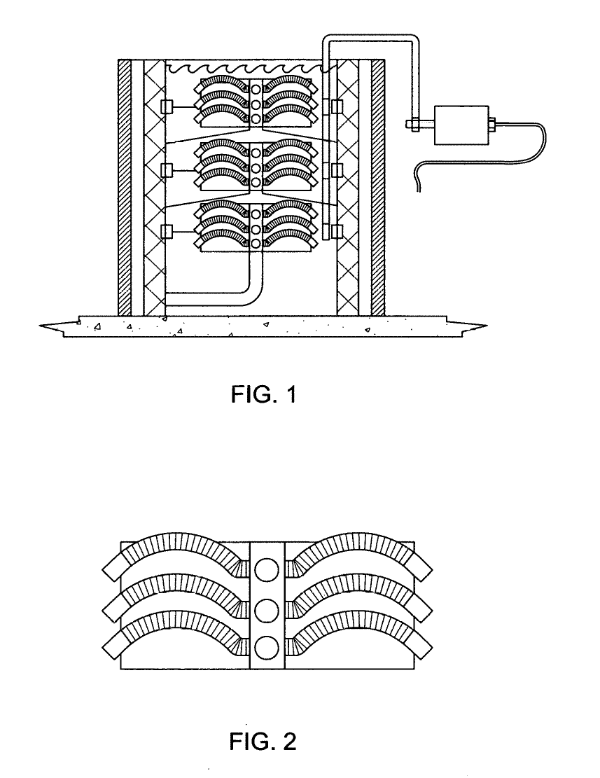

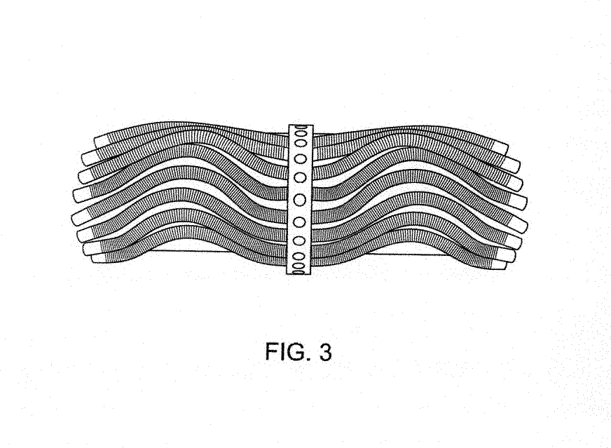

Note: all figures and numbers refer to the attached drawings (two pages) All mechanical equipment is submerged in a water bath containment tank (FIG. 1 No.7) a compressed air supply line (FIG. 2 No.1) delivers air to the first of three air jet impellers (FIG. 2 No.11). Air enters the entrapment chambers (FIG. 1 No.3) by way of the air injection ports (FIG. 1. No. 2) when ports are rotational positioned at their air reception point. As the air is injected into the air entrapment chambers it forces the water out the exhaust end of the air entrapment chamber, which is terminated at a downward angle thus exerting a position rotational thrust that assist the Hydraulic lifting force of the air in the containment chambers. The arched curve design of the air chambers keep the injected air trapped until the rotating impeller positions the open ends of the air filter chambers in an upward exhaust position allowing the air to escape. The submerged impeller air chambers are then gravitationally refilled with water which assist the rotational force to the impeller.

An air recapture compartment (FIG. 1 No. 4) are located between the first and second impeller then between the second and third impeller. The recaptured air is used to drive the second and third impeller similar to the first impeller. This multiple use of the injected air into the system gives a compounded energy force to the series of impellers which is then transferred to each impellers axle (FIG. 1 No. 5 Each axle has an attached hydraulic pump (FIG. 1 No.8) which pumps the hydraulic fluid to drive an electric generator (FIG. 1 No.9) the generator electricity is then distributed through a power line (FIG. 10 No 10) to a power grid system.

1. The air entrapment chambers are formed in an arched configuration to facilitate the maximum lifting force of the submerged air injection nozzle.

2. The air entrapment chambers are formed in a curved configuration to conform to the circular surface of the impeller.

3. The arched air entrapment chambers are left open at both ends of the air entrapment chambers.

4. The air entrapment chambers are formed as a set attached together at the mid length point of the impeller.

5. The air entrapment chambers receive the injected air at the midpoint of the impeller assembly.

6. The air injection ports at the midpoint of the impeller assembly have a baffle centrally located between the left side ports and right side ports to equalize the volume of air received by each air entrapment chamber.

7. The open exhaust ports of the air entrapment chambers terminate at the outer edges of the impeller assembly where the injected air expels the water downward from the air entrapment chambers; thus creating a thrust against the surrounding water—assisting the rotation of the impeller.

8. Multiple impellers are submerged horizontally in a tier, in a water filler cylindrical container.

9. An air injection nozzle mechanism attached to an air collection recompressing hood assemble services the second and third air jet impeller sets.

10. The foot pounds of energy from the air jet impeller axles is harnessed to drive electric generators by Hydraulic pumps.

11. The configuration of the air entrapment chambers maximizes the air lifting forces thus generating more electricity per cubic foot of air introduced.

12. The open ports design of air jet entrapment chambers allows for rapid air escape at the exhaust position and rapid water refill of chambers on the gravitational downward pull side of the impellers.

13. The operational process of using two Natural Renewal Elements, namely, Water and Air leaves no carbon foot print.

14. The air injection nozzle is house in an adjustable sliding skid frame allowing for advancing or retarding the air injection timing.

15. A used air hooded exhausted port is located at the top of the water containment tank designed to prevent exterior air particles from contaminating the interior water.

16. All component in contact with water are made or coated with rust resistive materials for extending their functional life span.
